(19) United States
(12) Patent Application Publication
(10) Pub. No.: US 2002/0052212 A1
(43) Pub. Date: May 2, 2002

(54) Method and system for transmitting short text information to a communications terminal

(76) Inventor: Alexander Aschir, Bangalore (IN)

Correspondence Address: BELL, BOYD & LLOYD, LLC, P. O. BOX 1135, CHICAGO, IL, 60690-1135, US

(21) Appl. No.: 09/947,975

(22) Filed: Sep. 6, 2001

(30) Foreign Application Priority Data
Sep. 6, 2000 (DE) 100 44 555.1

(51) Int. Cl. H04Q 7/20

(52) U.S. Cl. 455/466; 455/433

(57) ABSTRACT

A method and system for transmitting short text information to a communications terminal in a communications network wherein, in order to enlarge the field of application for short text information in communications networks, the short text information is addressed using a communication address which is not linked to any specific communications terminal, and the communication address, which is not linked to any specific communications terminal, for the short text information is then used by an address converter at the network end to replace this address by a communication address for the communications terminal, and the short text information is transmitted to this communications terminal.

### BACKGROUND OF THE INVENTION

The present invention relates to both a method and a system for transmitting short text information to a communications terminal in a communications network. Such a method is known from the document “Siemens S25 User Guide” dated September 1999, No. A31008-H3100-A1-3-7619, in particular from pages 22 and 23. It is evident from page 23 of this document that the sender of short text information uses the telephone number of a radio telephone to which the short text information is intended to be sent when sending this information.

The present invention is directed toward specifying a method and a system using which the field of application for short text information in communications networks can be enlarged.

### SUMMARY OF THE INVENTION

In the case of a method of the type mentioned initially, such objective is achieved according to the present invention in that the short text information is addressed to the communications terminal by a short information transmitter using a communication address which is not linked to any specific communications terminal. The communication address, which is not linked to any specific communications terminal, for the short text information is used by an address converter at the network end to replace this address by a communication address for the communications terminal, and the short text information is transmitted to this communications terminal. In this case, it is particularly advantageous for the sender of the short text information also to be able to address this information by using a communication address which is not linked to any specific communications terminal. Communication addresses which are not linked to any specific communications terminal are those which are not rigidly associated with any specific communications terminal. These addresses are also referred to as logical addresses. Such logical addresses occur, for example, in virtual private networks (VPN), in personal telephone numbers (PNS—Personal Number Service) or in other communications services which are controlled, for example, by intelligent networks (IN). The method according to the present invention allows short text information also to be used in services or applications in which communication addresses which are not linked to any specific communications terminal are used.

One advantageous embodiment of the method according to the present invention provides that the address converter is a network node in an intelligent network (IN) which is connected to the communications network or is contained in the communications network. Since communication addresses which are not linked to any specific communications terminal often occur in services which are carried out via an intelligent network, it is advantageous to allow the communication address which is not linked to any specific communications terminal for the short text information to be replaced by the communication address of the communications terminal by a network node in the intelligent network.

In a further advantageous embodiment of the method according to the present invention, the address converter is a service control point in the intelligent network which, with regard to the signal flow, is arranged between a short information service center and a home location register in the communications network. This is particularly advantageous because the method steps required for address replacement are essentially carried out by the service control point and no changes are required to the method of operation of the short information service centers and home location registers that are normally used these days.

One advantageous form of the method according to the present invention provides that the service control point is a service control point which is addressed by the short information service center in the same way as the home location register, and is addressed by the home location register in the same way as the short information service center.

The abovementioned object is likewise achieved according to the present invention by a system for carrying out the method described so far, which has an address converter which is associated with a communications network and replaces a communication address which is not linked to any specific communications terminal for short text information by a communication address for a communications terminal. The use of such a system allows the short text information to be addressed by the sender using a communication address which is not linked to any specific communications terminal. Once this communication address which is not linked to any specific communications terminal has been replaced by a communication address for a communications terminal, the short text information can be transmitted to this communications terminal.

The system according to the present invention also can be refined in such a manner that, as the address converter, this system has a network node in an intelligent network which is connected to the communications network or is contained in the communications network. Since communication addresses which are not linked to any specific communications terminal often occur in services which are carried out via an intelligent network (IN), it is advantageous to use a network node in an intelligent network as the address converter.

The system according to the present invention also can be refined in such a manner that, as the address converter, this system has a service control point in the intelligent network (IN) which, with regard to the signal flow, is arranged between a short information service center and a home location register in the communications network. This is particularly advantageous because the address replacement can be carried out essentially by the service control point, and no changes are required for the method of operation of the short information service centers and home location registers which are normally used these days.

The system according to the present invention also can be refined in such a manner that, as the service control point, this system has a service control point which is addressed by the short information service center in the same way as the home location register, and is addressed by the home location register in the same way as the short information service center.

Additional features and advantages of the present invention are described in, and will be apparent from, the following Detailed Description of the Invention and the Figures.

### BRIEF DESCRIPTION OF THE FIGURES

FIG. 1 shows an exemplary embodiment of a system for carrying out the method according to the present invention.

FIG. 2 shows an exemplary embodiment of the message flow when transmitting short text information.

FIG. 3 shows an exemplary embodiment of the message flow when the short text information cannot be transmitted to the communications terminal.

FIG. 4 shows an exemplary embodiment of the message flow for informing a short information service center that the communications terminal is ready to receive short text information.

### DETAILED DESCRIPTION OF THE INVENTION

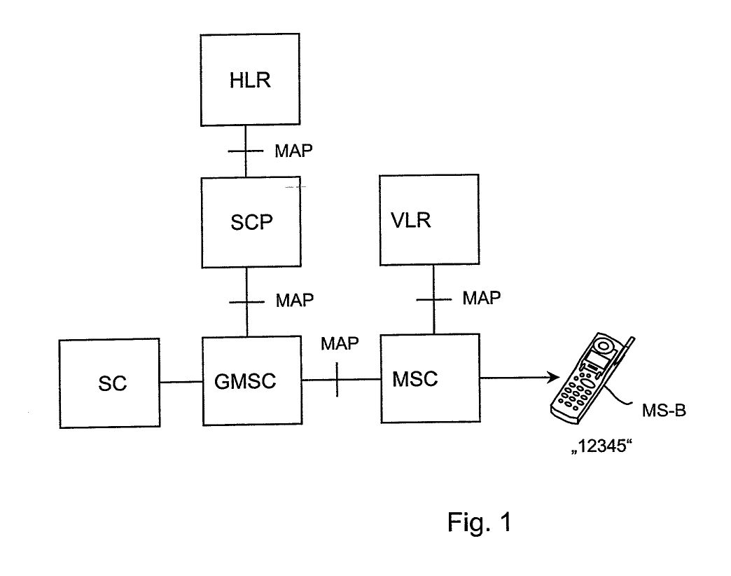

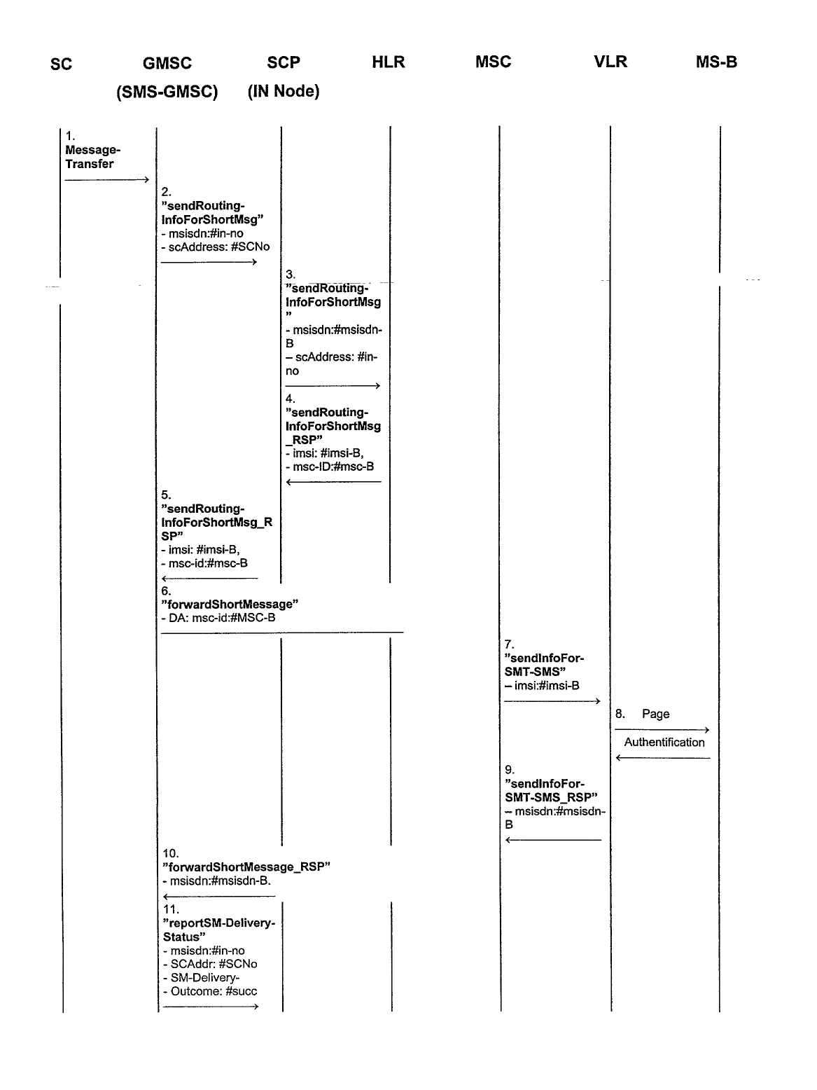

FIG. 1 shows a detail of a communications network. This arrangement will be used to explain how short text information (also referred to as a short message SM) which is addressed using a communication address which is not linked to any specific communications terminal is transmitted to a communications terminal. A communication address which is not linked to any specific communications terminal is, for example, what is referred to as a “lifelong telephone number” or “personal telephone number”, which is rigidly associated with a person, but not with a communications terminal. Other examples of communication addresses which are not linked to any specific communications terminal are toll-free telephone numbers (1-800 telephone numbers) or telephone numbers in virtual private networks (VPN). The communication address which is not linked to any specific communications terminal that will be used in this exemplary embodiment is a telephone number (for example, a personal telephone number) whose dialing initiates the provision of a service by what is referred to as an intelligent network (IN); telephone numbers such as these are also referred to as “IN service numbers”. To simplify the terminology, such a communication address which is not linked to any specific communications terminal also will be referred to in the following text as an “IN number”.

In this exemplary embodiment, the communications network is formed by a radio communications network (for example, a mobile radio network). The short text information addressed using the communication address (“IN number”) which is not linked to any specific communications terminal is transmitted in a known manner by a short information transmitter (for example, by a mobile communications terminal, a mobile telephone, etc.), which is not shown in FIG. 1, to a short information service center (SC) which is also referred to as a “Short Message Service Center” (SMS-SC) or a “Service Center”. The short information service center SC then transmits the short text information to a mobile switching center GMSC (Gateway Mobile Switching Center). Since the short text information is addressed using the IN number, the mobile switching center GMSC sends a message containing the IN number to a service control point SCP in an intelligent network. This is dependent on the mobile switching center GMSC being appropriately configured (for example, by adaptation of what is referred to as a routing database). This service control point SCP is used in the intelligent network to provide a service and to replace the IN number contained in the message, that is to say the communication address which is not linked to any specific communications terminal, by a communication address for a communications terminal; in this example, by a telephone number “12345” of a communications terminal MS-B (Mobile Station B). The service control point SCP thus acts as an address converter. The service control point SCP then sends the modified message onward to a home location register HLR in the communications network. The home location register HLR determines, in a known manner, the international mobile radio subscriber identity (International Mobile Subscriber Identity IMSI) of the communications terminal MS-B and an identity for a further mobile switching center MSC, in whose area of influence the communications terminal MS-B is located at the appropriate time. The international mobile radio subscriber identity and the identity for the further mobile switching center are now sent via a response message from the home location register HLR to the service control point SCP and from there to the mobile switching center GMSC.

The mobile switching center GMSC then sends the short text information to the further mobile switching center MSC, which uses a visitor location register VLR in a known manner to send the short text information to the communications terminal MS-B.

A particularly advantageous feature of the method according to the PRESENT invention is that the service control point SCP which, with regard to the message flow, is arranged between the short information service center SC and the home location register HLR, is addressed by the short information service center SC in the same way as a home location register HLR, and is addressed by the home location register HLR in the same way as a short information service center SC. Thus, in comparison to the currently known method for transmitting short text information, in which the home location register is addressed (generally via one or more mobile switching centers) by a short information service center SC, only minor modifications are required in the mobile switching center. Virtually all the activities that are new in comparison to the currently known method can be carried out by the service control point SCP. The method and system according to the present invention can, thus, be implemented relatively easily, quickly and at low cost.

The message interchange between the home location register HLR, the service control point SCP, the mobile switching center GMSC, the further mobile switching center MSC and the visitor location register VLR is carried out using a communication protocol which is referred to as a Mobile Application Part (MAP).

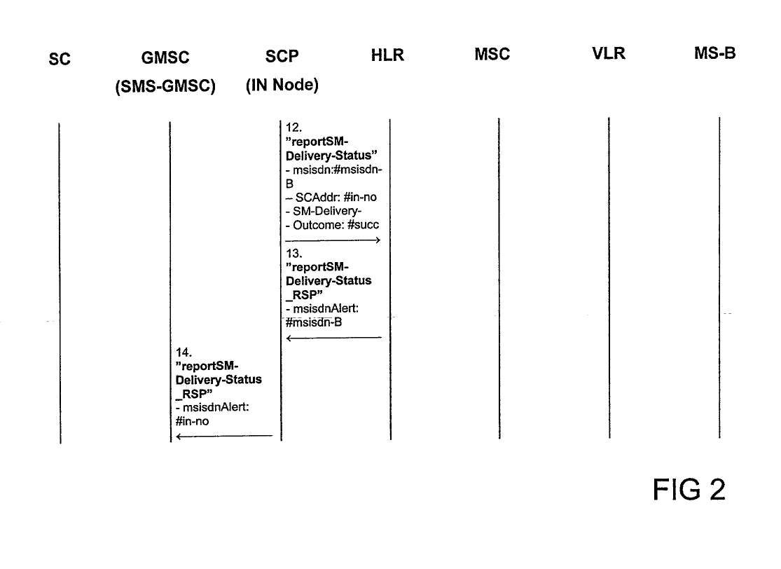

FIG. 2 shows, in detail, what messages are interchanged when transmitting short text information from the short information service center SC to the communications terminal MS-B. For this purpose, vertical lines are used to schematically illustrate the following units, which already have been shown in FIG. 1:

short information service center SC,

mobile switching center GMSC,

service control point SCP,

home location register HLR,

further mobile switching center MSC,

visitor location register VLR, and

communications terminal MS-B;

the horizontal arrows symbolize the messages sent between these units. The time sequence is from top to bottom.

At the start of the method according to the present invention, the short text information is sent from the short information service center SC to the mobile switching center GMSC (arrow 1). The mobile switching center GMSC then sends the sendRoutingInfoForShortMsg MAP message to the service control point SCP (arrow 2), with the communication address “#in-no” (the IN number) which is not linked to any specific communications terminal being sent as the parameter “msisdn” with the sendRoutingInfoForShortMsg message. Furthermore, the address “#SCNo” of the short information service center SC is transmitted as the parameter “scAddress”. In the sendRoutingInfoForShortMsg message, the service control point SCP replaces the communication address “#in-no”, which is not linked to any specific communications terminal, by the communication address “#msisdn-B” of the communications terminal MS-B, and replaces the address “#SCNo” of the short information service center SC by the communication address “#in-no” which is not linked to any specific communications terminal. The address “#SCNo” of the short information service center SC is stored temporarily in the service control point SCP. The service control point SCP then sends the modified sendRoutingInfoForShortMsg message on to the home location register HLR (arrow 3). In a known way, the home location register HLR determines the international mobile radio subscriber identity (IMSI) of the communications terminal MS-B and the identity of the further mobile switching center MSC which is responsible for the point where the communications terminal MS-B is located at the appropriate time. This information is sent back as the “imsi” and “msc-ID” parameters in a sendRoutingInfoForShortMsg_RSP message to the service control point SCP (arrow 4), which passes the message on without changing it to the mobile switching center GMSC (arrow 5).

The mobile switching center GMSC now has all the necessary information to send the short text information to the communications terminal MS-B. This is done in a known manner via messages which are symbolized by the arrows 6 to 10. Such a message flow is described in the document GSM 09.02, Version 5.3.0 from the ETSI (European Telecommunications Standards Institute) Organization, dated August 1996, in particular on page 562.

After receiving a forwardShortMessage_RSP message, symbolized by the arrow 10, the mobile switching center GMSC sends a reportSM-Delivery-Status message to the service control point SCP (arrow 11). As the “msisdn” parameter, this message contains the communication address (the IN number which was temporarily stored in the GMSC) which is not linked to any specific communications terminal. Furthermore, the reportSM-Delivery-Status message contains, as the “SCAddress” parameter, the address of the short information service center SC and, as the “SM-Delivery-Outcome” parameter, a confirmation that the short text information has been successfully delivered.

In the reportSM-Delivery-Status message, the service control point SCP replaces the IN number “#in-no” by the communication address “#msisdn-B” of the communications terminal MS-B, and replaces the address “#SCNo” of the short information service center SC by the communication address “#in-no”, which is not linked to any specific communications terminal. After this, the modified reportSMDelivery-Status message is passed on to the home location register HLR (arrow 12). The home location register HLR responds with the reportSM-Delivery-Status_RSP message which contains, as the “msisdnAlert” parameter, the communication address of the communications terminal MS-B. This message is sent to the service control point SCP (arrow 13). In the “msisdnAlert” parameter, the service control point SCP replaces the communication address of the communications terminal MS-B by the IN number, and sends the modified message back to the mobile switching center GMSC (arrow 14).

One action of the service control point SCP which is essential for the exemplary embodiment of the present invention is for it to replace the communication address “#in-no”, which is not linked to any specific communications terminal, by the communication address “#msisdn-B” of the communications terminal MS-B in the messages, and thus to allow the short text information to be transmitted to the communications terminal MS-B. The service control point SCP likewise replaces the address “#SCNo” of the short information service center SC by the communication address “#in-no” which is not linked to any specific communications terminal, and thus allows the insertion, related to the message flow, of the service control point SCP between the short information service center SC and the home location register HLR.

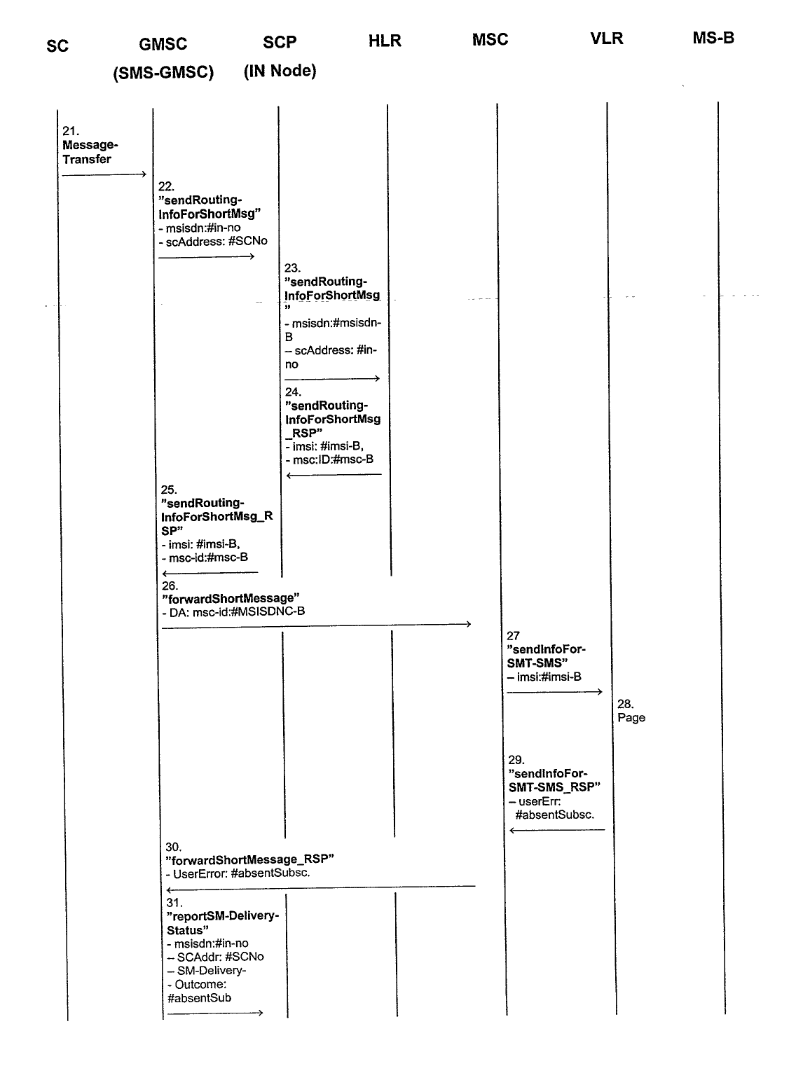

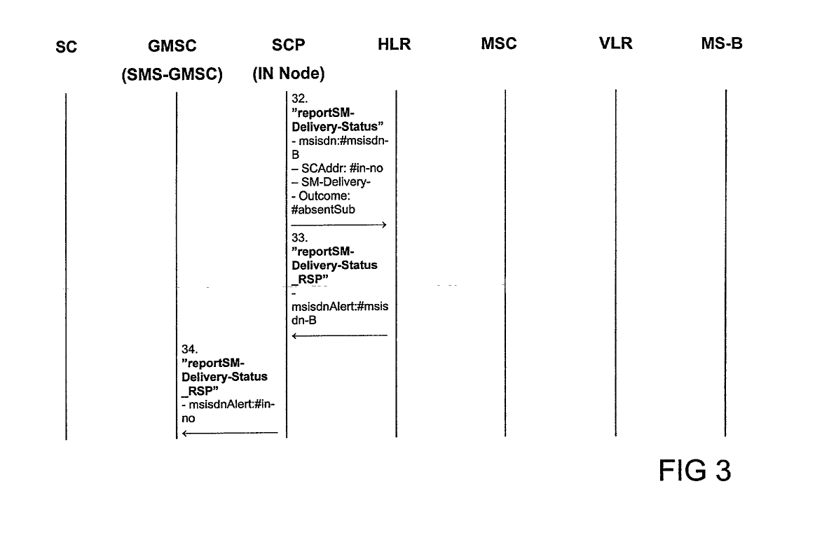

FIG. 3 shows the message flow when using the method according to the present invention when the short text message cannot be transmitted to the communications terminal MS-B which is used as a short message receiver; for example, because it is switched off, is not registered with the radio communications network, or the rechargeable battery of the communications terminal has fully discharged.

The messages symbolized by the arrows 21 to 28 correspond to the messages illustrated in FIG. 2. Once the message which is symbolized by the arrow 28 has been sent, the visitor location register VLR does not, however, in contrast to FIG. 2, receive a message from the communications terminal MS-B since it has not been possible to transmit the short text message to this communications terminal MS-B. The visitor location register VLR then sends a sendInfoFor-SMT-SMS_RSP message (arrow 29) to the further mobile switching center MSC, which message contains, as the “userErr” parameter, the information that it has not been possible to reach the communications terminal MS-B. The further mobile switching center MSC uses a forwardShortMessage_RSP message (arrow 30) to send this information on to the mobile switching center GMSC. The mobile switching center GMSC then sends a reportSM-Delivery-Status message (arrow 31) to the service control point SCP. This reportSM-Delivery-Status message contains, as the “msisdn” parameter, the communication address “#in-no” (IN number which has been temporarily stored in the GMSC), which is not linked to any specific communications terminal. Furthermore, the reportSM-Delivery-Status message contains, as the “SCAddress” parameter, the address of the short information service center SC and, as the “SM-Delivery-Outcome” parameter, a report that it has not been possible to transmit the short text information to the communications terminal MS-B.

In the reportSM-Delivery-Status message, the service control point SCP replaces the communication address “#in-no”, which is not linked to any specific communications terminal, by the communication address “#msisdn-B” of the communications terminal MS-B, and replaces the address “#SCNo” of the short information service center SC by the communication address “#in-no”, which is not linked to any specific communications terminal. The modified reportSM-Delivery-Status message is then passed on to the home location register HLR (arrow 32). The home location register HLR now sets a “MessageWaitingFlag” (not illustrated in FIG. 3), which indicates that it has not been possible to transmit the short text message to the communications terminal MS-B. The home location register HLR then sends a reportSM-Delivery-Status_RSP message(arrow 33) to the service control point SCP. This reportSM-Delivery-Status_RSP message contains, as the “msisdnAlert” parameter, the communication address of the communications terminal MS-B. In the “msisdnAlert” parameter, the service control point SCP replaces the communication address of the communications terminal MS-B by the IN number, and sends the modified reportSM-Delivery-Status_RSP message back to the mobile switching center GMSC (arrow 34).

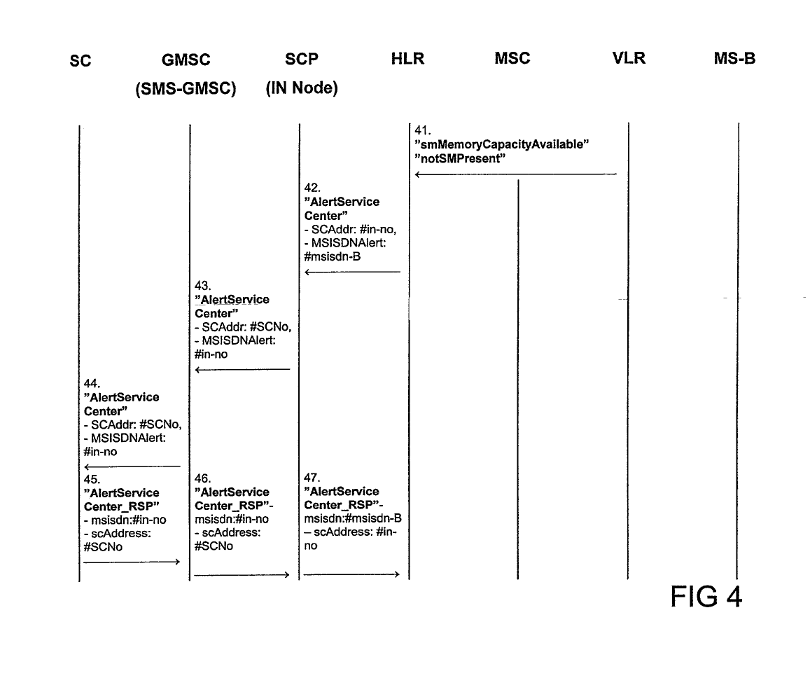

FIG. 4 shows how the short information service center SC is informed when the communications terminal MS-B is once again ready to receive short text information. The original information at the start of the process illustrated in FIG. 4 is that in which an unsuccessful attempt was previously made to send short text information to the communications terminal MS-B. For example, the communications terminal MS-B was switched off, so that it was impossible to transmit the short text information. A “MessageWaitingFlag” was then set in the home location register HLR, and the IN number (that is to say the communication address “#in-no”, which is not linked to any specific communications terminal, to which the short text information to be delivered was addressed) was stored.

As soon as the communications terminal MS-B is once again able to receive short text information (for example, because it has been switched on again), an smMemoryCapacityAvailable message or a notSMPresent message (arrow 41) is sent from the visitor location register VLR to the home location register HLR. The home location register HLR then sends an AlertServiceCenter message (arrow 42) to the service control point SCP. This message contains, as the “SCAddress” parameter, the IN number “#in-no” which was stored in the home location register HLR. Furthermore, as the “MSISDNAlert” parameter, the message contains the MSISDN of the communications terminal MS-B. In the “SCAddress” parameter, the service control point SCP replaces the IN number by the address, which was previously stored in the service control point, of the short information service center SC and, in the “MSISDNAlert” parameter, replaces the MSISDN of the communications terminal MS-B by the IN number. The modified AlertServiceCenter message is then sent on to the mobile switching center GMSC (arrow 43). The mobile switching center GMSC then sends the modified AlertServiceCenter message on to the short information service center SC (arrow 44). The short information service center SC then sends, as its response, the AlertServiceCenter_RSP message (arrow 45) to the mobile switching center GMSC. This AlertServiceCenter_RSP message contains the address “#SCNo” of the short information service center SC and, as the destination details, the IN number “#in-no”. This message is passed on on the basis of the IN number from the mobile switching center GMSC to the service control point SCP (arrow 46). The service control point SCP replaces the IN number “#in-no” by the communication address “#msisdn-B” of the communications terminal MS-B, and replaces the address “#SCNo” of the short information service center SC by the IN number “#inno”. It then sends the modified AlertServiceCenter-RSP message on to the home location register HLR (arrow 47). The short text message is then transmitted to the communications terminal MS-B in the known manner.

The method and system according to the present invention make it possible, for example, to address short text information, which is referred to as a short message, using an IN service telephone number. This considerably extends the usefulness of intelligent networks (IN) since, in addition to the already known voice-based services provided by intelligent networks, the use of the short message service system via intelligent networks now also allows data-based services to be provided; for example, sending short messages to different destinations depending on variables such as the day of the week, the time or the location of the sender, or flexible charging for short messages.

Although the present invention has been described with reference to specific embodiments, those of skill in the art will recognize that changes may be made thereto without departing from the spirit and scope of the invention as set forth in the hereafter appended claims.

1. A method for transmitting short text information to a communications terminal in a communications network, the method comprising the steps of:
addressing the short text information to the communications terminal by a short information transmitter using a communication address which is not linked to any specific communications terminal;
using the communication address, which is not linked to any specific communications terminal, by an address converter at a network end to replace the communication address by a communication address for the communications terminal; and
transmitting the short text information to the communications terminal.

2. A method for transmitting short text information to a communications terminal in a communications network as claimed in claim 1, the method further comprising the step of:
providing, as the address converter, a network node in an intelligent network associated with the communications network.

3. A method for transmitting short text information to a communications terminal in a communications network as claimed in claim 2, the method further comprising the steps of:
providing, as the address converter, a service control point in the intelligent network; and
arranging the service control point, with regard to signal flow, between a short information service center and a home location register in the communications network.

4. A method for transmitting short text information to a communications terminal in a communications network as claimed in claim 3, the method further comprising the steps of:
addressing the service control point by the short information service center in a same way as the home location register; and
addressing the service control point by the home location register in a same way as the short information service center.

5. A system for transmitting short text information to a communications terminal in a communications network, comprising:
a short information transmitter for addressing the short text information to the communications terminal using a communication address which is not linked to any specific communications terminal; and
an address converter associated with a communications network, the address converter replacing the communication address which is not linked to any specific communications terminal for short text information by a communication address for the communications terminal, the short text information being transmitted to the communications terminal.

6. A system for transmitting short text information to a communications terminal in a communications network as claimed in claim 5, wherein a network node in an intelligent network is provided as the address converter, the network node being associated with the communications network.

7. A system for transmitting short text information to a communications terminal in a communications network as claimed in claim 6, wherein a service control point in the intelligent network is provided as the address converter, the service control point being arranged, with regard to signal flow, between a short information service center and a home location register in the communications network.

8. A system for transmitting short text information to a communications terminal in a communications network as claimed in claim 7, wherein the service control point is addressed by the short information service center in a same way as the home location register, and the service control point is addressed by the home location register in a same way as the short information service center.
